(19) United States
(12) Patent Application Publication
(10) Pub. No.: US 2012/0034485 A1
(43) Pub. Date: Feb. 9, 2012

(54) WALL FACING PANEL

(76) Inventor: Andrey Vilenovich Lyubomirskiy, Moscow (RU)

(21) Appl. No.: 13/138,819

(22) PCT Filed: Mar. 29, 2010
(86) PCT No.: PCT/RU2010/000139

§ 371 Date: Sep. 29, 2011

(30) Foreign Application Priority Data
Mar. 31, 2009 (RU) 2009111478

(51) Int. Cl. B32B 3/30; B32B 15/00

(52) U.S. Cl. 428/600; 428/173

(57) ABSTRACT

A wall facing panel has a base of sheet metal and on a front face of which there are convex elements and/or concaves producing a textured design; the convex elements are made with a diameter of 0.001 mm to 25 mm, and the concaves are made with 0.01 mm to 25 mm and a depth not exceeding 0.95d where d is the thickness of sheet material; the design is made in conformity with the condition S_{conv}/S_{conc.}=0.05−19.0 where S_{conv.} is the combined area of the convex of the convex elements, and S_{conc} is the combined are of the concaves, and the metal base is made with the thickness d=0.02-5.0 mm. The textured design has regular spacing of the convex elements and concaves on the front face of the panel, with random spacing of the convex elements and concaves, or with a mix of regular and random spacing of the convex elements and concaves on the front face of the panel.

This invention is for improvements in or relating to the design of wall facing panels with textured surface and can be used in products designed for both indoor and outdoor wall panelling.

There is the decorative panel [1] which has a metal base and a decorative element in the form of a stencilled printed design with a tin layer in between the metal base and the decorative element; the tin layer can be, for example, anodized coating applied to the metal base, and the area occupied by the decorative coating accounts for 50 per cent of the base. There is also the functional and decorative wall panel [2] consisting of a flat metal sheet base, which is fastened to the wall, affixed with fixture elements to the functional and decorative elements on the outer surface of the wall panel; of the decorative layer on the outer side of the wall panel fastened to the base; and of the elastic padding built into the inner side of the panel; the decorative layer is made of a sheet polymer material; the elastic padding is made of flexible sheet material; in the decorative layer and in the base there are apertures spaced at regular intervals from each other along the vertical and horizontal axes; the fixture elements for the functional and decorative elements have hold-down heads fixed to the inner side of the wall panel; the said apertures have a profile that allows for easy insertion of the head of the fixture element into the front side of the wall panel and for the hold-down of the fixture element by the said head from the inner side of the wall panel; the wall panel is divided into sections that are abutted closely to one another on their flanks during the assembly of the wall panel.

The undesirable feature of the prior art decorative panels [1,2] is their structural complexity caused by the fact that they are not single-layer.

There is the metallic wall panel which is a rectangular metal sheet with its edges deflected along the entire perimeter of the sheet, making an acute angle to its front side with a decorative relief; the decorative relief is made by the rectilinear and/or curvilinear elongated ledges (collars) created by high-pressure treatment of the sheet material and positioned symmetrically to the point of intersection of the diagonals of the front surface; and the height of the elongated ledges is more than the thickness of the metal sheet [3].

The undesirable feature of the aforesaid metallic wall panel is that it has low performance characteristics. Indeed, applying high-pressure treatment to the sheet material to create the decorative relief on the front surface of the panel with the height of the elongated ledges bigger than the thickness of the metal sheet puts tight restrictions on the thickness of the metal sheet and the mechanical properties of the material it is made of. To manufacture the prior art metallic wall panel, it is not possible to use high-performance metal sheets with a thickness of over 0.8 mm made of high-strength alloy steel with high anticorrosion properties and mechanical strength.

There is also the metallic wall panel [4] having a rectangular aluminium base, on the front face of which there are ledges made of natural stone granules glued to the base.

The undesirable features of the prior art engineering solution are the low durability of the metallic wall panel and its low performance indicators since the prior art engineering solution does not assure the high durability of the metallic wall panel.

Closest to the proposed technical solution in its technical spirit is the prior art metallic wall panel [5] which consists of a stainless-steel metal base with decorative elements ,on its front face; the decorative elements are made in the form of concaves on its front face filled with dye of appropriate colour either on a level with or no more than 0.14 mm above the front face level by the powder coating method.

The prior art technical solution is limited in its use due to the simplified fabrication technology (using the powder coating method for filling the concaves with dye either on an equal level with or up to a level of no higher than 14 mm from the surface of the front face) which makes it impossible to achieve high quality of the product and ensure the product possesses high consumer properties.

An object, which is realised through the implementation of the designed product, is to create a new type of wall panels

The technical result obtained through the implementation of the designed product is the creation of a dirt-resistant vandal-proof wall panel which could preserve its consumer properties over a longer period of time.

To achieve the said technical result, it is proposed to use a wall panel made of sheet metal on the front face of which there are elements making up a textured design containing convex elements and concaves; the convex elements are made with a diameter of 0.01 mm to 25 mm, and the concaves with a width of 0.1 mm to 25 mm and a depth not exceeding 0.95 d where d is the thickness of the sheet material; the design is made in conformity with the condition S_{conv}/S_{conc}=0.05−19.0 where S_{conv}. is the combined area of the convex elements, and S_{conc} is the combined are of the concaves, and the metal base is made with the thickness d=0.02−5.0 mm. The metal base is preferably made of stainless steel or an aluminium alloy. The said design pattern may be done by spacing the convex elements and concaves regularly on the front face of the panel thus producing an ornament. The said design pattern may be done by spacing the convex elements and concaves in a random fashion on the front face of the panel thus producing a chaotic design pattern. It can also represent a mix of regularly and randomly spaced convex elements and concaves on the front face of the panel thus producing a pattern that features groups of convex and concave elements positioned in between the elements of the ornament.

In addition, to achieve the said technical result, it is proposed to use a wall panel which base is made of sheet metal and on the front face of which there are convex elements and concaves making up a textured design; the convex elements are made with a diameter of 0.01 mm to 25 mm, and the concaves with a width of 0.01 mm to 25 mm and a depth not exceeding 0.95 d where d is the thickness of the sheet material; the design is made in conformity with the condition S_{conv}/S_{conc}=0.05−19.0 where S_{conv} is the combined area of the convex elements, and S_{conc} is the combined are of the concaves, and the metal base is made with the thickness d=0.02−5.0 mm. The metal base is preferably made of stainless steel or an aluminium alloy. The design pattern may be done by spacing the convex elements and concaves regularly on the front face of the panel thus producing an ornament. The design can be made with the convex elements and concaves spaced in a random fashion thus producing a chaotic design pattern and in a mix of regular and random spacing of the convex elements and concaves on the front face of the surface of the panel thus creating a design pattern in between the elements of which there are randomly spaced groups of convex elements and concaves. Polymers, composite materials or paint can be used as hardened medium for filling the concave elements of the textured surface of the panel.

The said technical result is achieved in the provided wall panel through the three embodiments of the textured surface of the panel given its indicated specifications (dimensions):

the texture of the surface features regular convex elements and concaves that make up an ornament;

the texture of the surface features randomly spaced convex elements and concaves that make up a chaotic design pattern;

the texture of the surface is a mix of regular and random spacing of the concave and convex elements on the front face of the panel that make up a pattern that features groups of convex and concave elements positioned in between the elements of the ornament.

Polymers or composite material or dye are used as hardened medium filling the cavities of the textured surface.

During the development of the wall panel design, it was experimentally deduced that the width and the depth of the ledges and cavities of the decorative texture is absolutely crucial for this type of wall panels.

The tests and the research have revealed that the minimum possible width that makes economic sense is 0.01 mm. Further reduction of the width does not make sense because it is difficult for the human eye to discern such small objects. In addition, from the technological point of view, cavities smaller than 0.01mm can be made by the costly photolithographic technique. The objects larger than 0.01 can be fabricated by the inexpensive techniques like tampon printing.

The use of micro-relief with the said dimensions filled with dyed medium (dye, dyed composite) makes it possible to protect the aforesaid dyed medium in the relief cavities from the damage that solid bodies may cause. In this case, the metallic ledges encircling the polymer perform the protective function. The smaller the width of the cavity filled with the dyed medium is, the smaller the chances are that the dyed medium will be damaged in the process of use. Usually, in an urban environment, vandals more frequently use metallic coins, lock keys, less frequently penknives, i.e. the things that every man has at his disposal in public places. Below are the specifications of coins:

the ten-kopek coin has a diameter of 17.5 mm and a thickness of 1.1 mm; made from a copper-base alloy.
the fifty-kopek coin has a diameter of 19.4 mm and a thickness of 1.4 mm; made from a copper-base alloy.
the one-rouble coin has a diameter of 20.5 mm and a thickness of 1.3 mm, made from a steel-base alloy.
the two-rouble coin has a diameter of 23 mm and a thickness of 1.8 mm; made from a steel-base alloy.
the two-rouble coin has a diameter of 25 mm and a thickness of 1.8 mm; made from a steel-base alloy.

The analysis of the geometric dimensions and the materials used in the production of the coins shows that the small-denomination coins of 10 and 50 kopeks made from soft copper-base alloys will not cause considerable damage to the decorative coatings of the panels. Moreover, the small size of the coins will not allow a vandal, without devoting a considerable physical effort, to have a firm grip on the coin by his thumb and index finger to ensure a significant part of the coin protrudes from in between the fingers. However, a vandal can easily have a firm grip on the coins with denominations of 1, 2 and 5 roubles between his fingers, in particular the five-rouble coin which has a diameter of 25 mm and a thickness of 1.8 mm.

During the testing of the relief characteristics, experiments were conducted with textured-surface sheet materials; the textured surface featured convexes and concaves, with the concaves filled with polymer powder paints based on the epoxy resin 3A-20 with a curing temperature of around 200° C. in the oven for five minutes. The width of the cavities in the relief used in the test varied from 0.01 mm to 50 mm. The relief cavities were either fully or half filled with the hardened dye. The force applied to the coin was within the range of 5 to 10 kg. The generatrix of the coin had a knurled profile.

Taking into account that the dye has a certain hardness which depends on the chemical composition of the binding agent (epoxide, polyester, polyurethane), it is evident that the value of resistance to the process of cutting of the surface by the coin changes. Moreover, the composition of dyes often includes fillers such as glass micro powder which have a high hardness value. In addition, the fact was taken into consideration that not all vandals can scratch the surface of a panel by a blunt coin for a long time, because it requires a strenuous physical effort. There is a need to bear in mind that the force of cutting as a coin scratches the cavities of the decorative relief should be huge so as to “get” to the bottom of the dyed cavity (filled with a polymer or a composite).

Numerous experiments conducted with the five-rouble coin have revealed that the biggest permissible width of the relief is 25 mm.

In other words, the optimal width of the cavity filled with dye is within the range of 0.01 mm to 25 mm.

In addition, it should be noted that the wall panel has another important consumer feature, which is that scratches are unnoticeable.

During the course of tests, it has been shown that a scratch on the dyed metal becomes noticeable when there appears a sharp contrast between the dyed and the undamaged surface and the gleam of the bear metal surface. If as a result of an act of vandalism a gleam of bear metal becomes visible on the monotonously dyed surface, a man subconsciously understands that there is a scratch in that place. With a width of less than 25 mm such scratches will be fewer in number as their length is limited to the same 25 mm. If scratches do appear, these will not be lines but rather barely visible specks instead.

In addition, the coating itself is an interlacing (from the point of view of the observer who does not have the knowledge of the composition and structure of the coating) of dyed and non-dyed patches some of which have a certain colour. All other patches are gleams of the metal surface and, above all, stainless steel. For a lay observer without special optical tools, it would be difficult to discern whether a gleam comes from an non-dyed patch, a ledge of the decorative relief or from a small scratch in the relief cavity which appeared as a result of an act of vandalism.

With a width of the relief elements ranging between 0.01 mm to 25 mm, fingerprints become invisible as well; fingerprints are one of the most common causes of dirt smearing a polished surface.

With the given width of the relief, it is easy to clear it of dust and other types of dirt.

The following are the important factors that influence the depth of the relief:

the quality of the dyed relief filler to hide the metal surface (to ensure the metal surface does not shine through the layer of the dyed filler). During the course of tests, it has been found that you can use a flat layer of the coloured filler with a thickness of 20-200 micron.
under the impact of sun rays and above all ultraviolet, the relief filler—the dye—becomes less thick due to the destruction of the colouring agent's molecules and sublimation of the results of destruction of macromolecules; reducing the depth of the relief while preserving the performance characteristics of the wall panel makes it possible to reduce the thickness of the panel, which leads to a reduction of its cost due to the decrease in the mass of the material, simplification of the panel fabrication technology, and the fact that it becomes easier to fasten the panel to the wall;
the dimensions of the fillers of the dyed matter. It has been found in the course of tests that the depth of the relief should be between 2 to 4 times more than the diameter of the biggest particle of the filler.

Taken the aforementioned into account, a series of experiments was conducted which revealed that the relief depth must not exceed the value of 0.95 d where d stands for the thickness of sheet material.

The experiments to study the discernibility of scratches, fingerprints and to clean the surface have showed that a decorative design must be made in accordance with the following condition: S_{conv}/S_{conc}=0.05−19.0 where S_{conv} is the combined area of the convex elements, and S_{cone} is the combined area of the concaves, with the metal base having a thickness of d=0.02−5.0 mm.

The spirit of the invention of the provided wall facing panel is illustrated in the drawings:

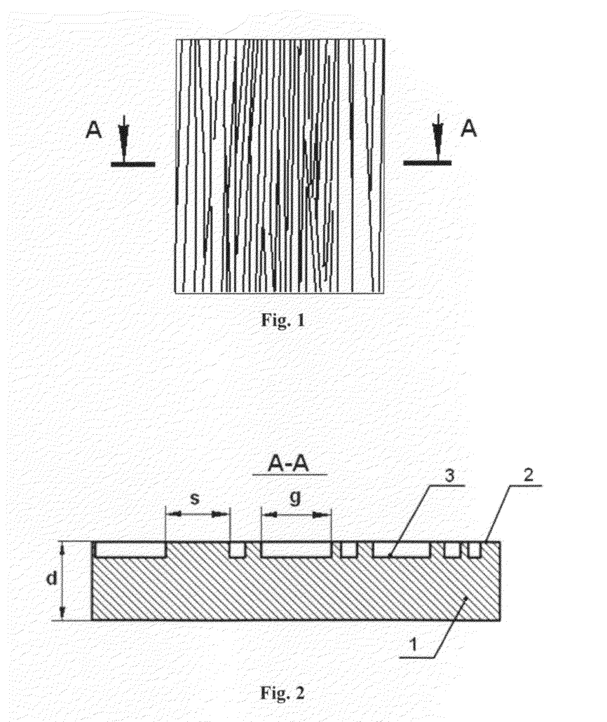

FIG. 1 shows a fragment of the metallic wall pane, its front face view;

FIG. 2 shoes the cross-section along the panel A-A showed in FIG. 1;

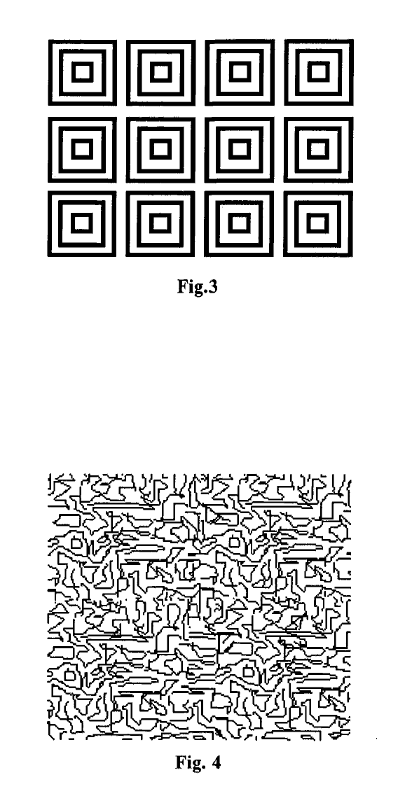

FIG. 3 shows the textured design on the front face of the wall panel with the textured elements spaced in a regular fashion;

FIG. 4 shows the textured design on the front face of the wall panel with the textured elements spaced in a random fashion;

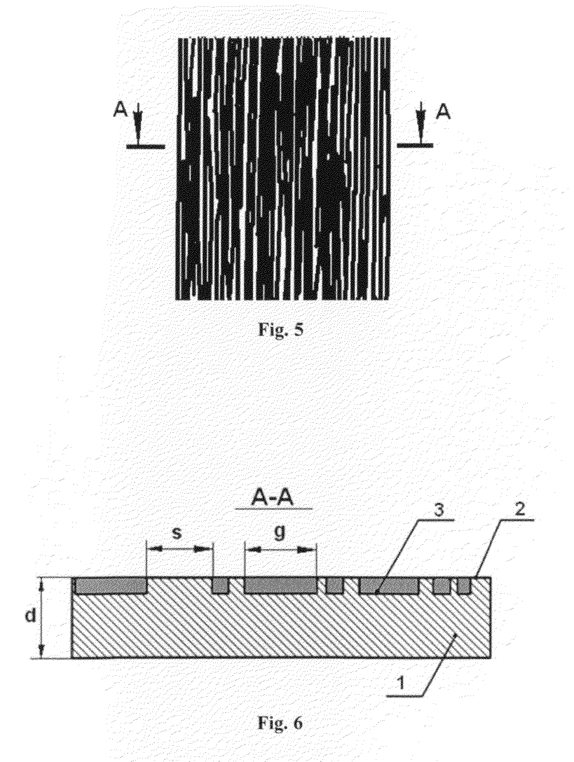

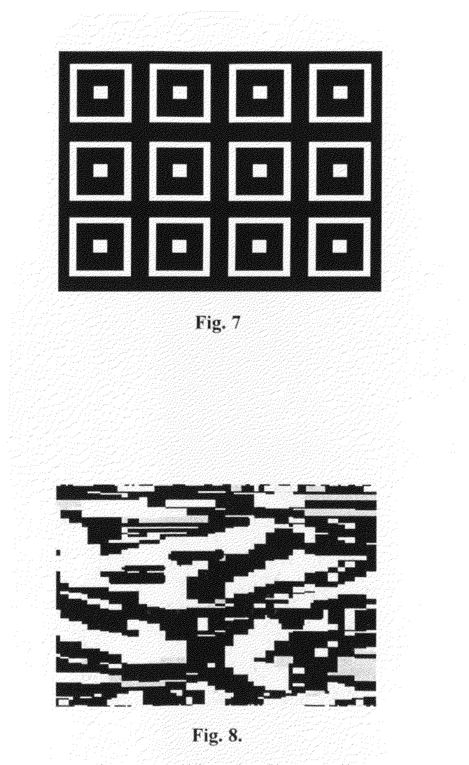

FIG. 5-8 show the textured design with the concaves filled with hardened medium.

On the wall panel 1 (FIG. 1, FIG. 2) the convex elements 2 are made with a width of 0.01 mm to 25 mm and the concaves with a width of 0.01 mm to 25 mm and a depth not exceeding 0.95 d where d stands for the thickness of the sheet material, with the decorative design made in conformity with the condition S_{conv}/S_{conc}=0.05−19.0 where S_{conv.} is the combined area of the convex elements, and S_{conc} is the combined area of the concaves.

The provided wall panel is fabricated and operates in the manner as follows.

The metallic wall panel 1 (FIG. 1) is fabricated, for example, of a sheet of stainless steel or a sheet of an aluminium alloy.

The relief design with the said geometric parameters can be made on the outer decorative layer 1 by the method of chemical etching, for example; prior to etching, a protective mask must be applied using by template web printing technique and etching of the unprotected patches by the etching solution; as a result, a relief design is created in the metal tape with the concaves etched to the aforesaid value.

After that the concaves of the textured surface are filled with dye which subsequently hardens under the ultraviolet or infrared radiation (FIG. 5-FIG. 8).

The decorative design is done in conformity with the condition S_{conv.}/S_{conc}=0.05−19.0 where S_{conv}. is the combined area of the convex elements, and S_{conc} is the combined area of the concaves.

The said ratios of the geometric parameters of the convex and concave elements make it possible to create relief designs of any degree of complexity.

Thus the design features distinguishing the provided wall panel from the prior art are dependent, through the relation of cause and effect, on the attainable technical result, which is the creation of a dirt-resistant_{.} vandal-proof wall panel which could preserve its consumer properties over a longer period of time.

The fastening of the panel to the surface that needs panelling is done by the prior art methods: the panels are glued using an appropriate adhesive composition or fastened by fixture elements.

The materials used in this wall panel are highly resistant to external impact, have anti-vandal protective properties and ensure a long operating life of the product.

The wall panel is preferably fabricated of stainless steel (brands X18H25C2, X18H9, 08X18H10, 08X18H9T, 12X18H9, 12X18H9T, and the like) or a sheet of an aluminium alloy of the brands AK-1, ATI-7, AJI-8, AJI-9 with the thickness d=0.1−5.0 mm.

Information sources:

### 1. Patent of the Russian Federation No. 2780, IPC B44C 5/04, 1995.

### 2. Patent of the Russian Federation No. 54338, IPC B44F 5/00, 2006.

### 3. Patent of the Federal Republic of Germany No. 2903359, IPC B44F, B44C1980/04, 1980.

### 4. Patent of the Federal Republic of Germany No. 3929761, IPC B44F, 1991.

5. Patent of the Russian Federation No. 66383; IPC E04F 13/12, 2006.

1-15. (canceled)

16. A wall panel, comprising a base of sheet metal and on a front face of which there are elements selected from the group consisting of convex elements, concaves and both producing a textured design, wherein the convex elements have a diameter of 0.01 mm to 25 mm, and the concaves have a width of 0.01 mm to 25 mm and a depth not exceeding 0.95 d where d is a thickness of a sheet metal; wherein the design is made in conformity with the condition S_{conv}/S_{conc}=0.05−19.0 where S_{conv}. is a combined area of the convex elements, and S_{conc} is a combined area of the concaves, and the metal base has a thickness d=0.02−5.0 mm.

17. The wall panel defined in claim 16, wherein the metal base is of stainless steel.

18. The wall panel as defined in claim 16, wherein the metal base is of an aluminum alloy.

19. The wall panel as defined in claim 16, wherein the design includes the convex elements and concaves spaced regularly on the front face of the panel thus producing an ornament.

20. The wall panel as defined in claim 16, wherein the design includes the convex elements and concaves spaced randomly on the front face of the panel thus producing a chaotic pattern.

21. The wall panel as defined in claim 16, wherein the design includes a mix of regularly and randomly spaced convex elements and concaves on the front face of the panel thus producing a pattern with groups of convex and concave elements position in between elements of an ornament.

22. A wall panel, comprising a base of sheet metal and on a front face of which there are elements selected from the group consisting of convex elements, concaves and both producing a textured design, wherein the convex elements have a diameter of 0.01 mm to 25 mm, and the concaves have a width of 0.01 mm to 25 mm, and the concaves have a width of 0.01 mm to 25 mm and a depth not exceeding 0.95 d where d is a thickness of a sheet material and filled with hardened medium; wherein the design is made in conformity with a condition S_{conv}/S_{conc}=0.05−19.0 where S_{conc.} is a combined area of the convex elements, and S_{conc} is a combined are of the concaves, and the metal base has a thickness d=0.02−5.0 mm.

23. The wall panel as defined in claim 22, wherein the metal base is of stainless steel.

24. The wall panel as defined in claim 22, wherein the metal base is of aluminum alloy.

25. The wall panel as defined in claim 22, wherein the design includes the convex elements and concaves spaced regularly on the front face of the panel thus producing an ornament.

26. The wall panel as defined in claim 22, wherein the design includes with the convex elements and concaves spaced randomly on the front face of the panel thus producing a chaotic pattern.

27. The wall panel as defined in claim 22, wherein the design includes a mix of regularly and randomly spaced convex elements and concaves on the front face of the panel thus producing a pattern with groups of convex and concave elements positioned in between elements of an ornament.

28. The wall panel as defined in claim 22, wherein polymers are used as hardened medium filling cavities of a textured surface.

29. The wall panel as defined in claim 22, wherein composite material is used as hardened medium filling cavities of a textured surface.

30. The wall panel as defined in claim 22, wherein dye is used as hardened medium filling cavities of a textured surface.
